(19) United States
(12) Patent Application Publication
(10) Pub. No.: US 2025/0196313 A1
(43) Pub. Date: Jun. 19, 2025

(54) ALLEN WRENCH GRIP

(71) Applicant: Eric Richards, Cottondale, AL (US)

(72) Inventor: Eric Richards, Cottondale, AL (US)

(21) Appl. No.: 18/541,789

(22) Filed: Dec. 15, 2023

(51) Int. Cl. B25G 1/00; B25G 1/10; B25G 3/02

(52) U.S. Cl. CPC B25G 1/005; B25G 1/102; B25G 3/02

(57) ABSTRACT

An Allen wrench grip that is used in combination with an Allen wrench or a Hex wrench that provides more comfort, speed, precision, and torque than using a standalone Allen wrench or Hex wrench. The Allen wrench grip includes a handle style grip embodiment, a shaft style grip embodiment, and a removable shaft style embodiment. The handle style grip embodiment includes an elongated gripping surface having a plurality of relatively hard, smooth plastic strips disposed lengthwise across the elongated screwdriver handle and a plurality of relatively soft, tactile rubber strips. The shaft style grip embodiment includes an extending shaft extending from the top surface that includes a slot and a pair of apertures. The removable shaft style includes a hollow body, a pair of grasping notches, a pair of end notches, and a pair of apertures.

### BACKGROUND OF THE INVENTION

The present invention relates to a wrench grip. More specifically, the present invention relates to an Allen wrench grip.

Allen wrenches are typically very hard to use. The L shape handle that accompanies an Allen wrench does not feel good or right being grasped at any angle.

What is needed is an Allen wrench grip that is used in combination with an Allen wrench or a Hex wrench that provides more comfort, speed, precision, and torque than using a standalone Allen wrench or Hex wrench.

### SUMMARY OF THE INVENTION

In view of the foregoing disadvantages inherent in the known types of Allen wrench grips now present in the prior art, the present invention provides an Allen wrench grip wherein the same may be utilized in combination with a standard Allen wrench for more comfort, speed, precision, and torque than using a standalone Allen wrench or Hex wrench.

The present invention relates to a wrench grip. More specifically, the present invention relates to an Allen wrench grip.

One embodiment of the present system comprises a handle style Allen wrench grip, having an elongated screwdriver handle having an elongated gripping surface, an indented portion, a raised portion, and a top portion, a plurality of holes including a first hole, a second hole, a third hole, and a fourth hole, the first hole is disposed on the top portion of the elongated screwdriver handle to accommodate an Allen wrench, wherein the second hole, the third hole, and the fourth hole are disposed on the elongated screwdriver handle to accommodate the Allen wrench, and wherein the Allen wrench includes a first elongated portion, a second elongated portion, a first end, and a second end.

Another embodiment of the present system comprises a shaft style Allen wrench grip, having a bulb-shaped handle having a raised rounded middle to facilitate grasping the raised rounded middle and a top surface, and an extending shaft extending from the top surface, the extending shaft includes a slot and a pair of apertures, wherein the pair of apertures include a first aperture and a second aperture, wherein the extending shaft is hollow to receive an Allen wrench, wherein the Allen wrench includes a first elongated portion, a second elongated portion, a first end, and a second end, and the slot and the pair of apertures are hollow to receive the Allen wrench.

Another embodiment of the present system comprises a removable shaft style Allen wrench grip, comprising an elongated handle having a plurality of raised edge surfaces, a plurality of tactile surfaces, a plurality of indentations, and a top surface, a removable shaft including a hollow body, a pair of grasping notches, a pair of end notches, and a pair of apertures, and a pair of Allen wrenches, wherein the raised edge surfaces, the tactile surfaces, and the indentations facilitate grasping the elongated handle and provide ergonomic comfort.

It is an object of the present invention to provide an Allen wrench grip that is used to grasp an Allen wrench at a plurality of different angles.

It is an object of the present invention to provide an Allen wrench grip used in combination with a traditional Allen wrench that is easier, faster, and more comfortable to use than a standalone traditional Allen wrench.

It is an object of the present invention to provide an Allen wrench grip that is used with any sized Allen wrench.

It is an object of the present invention to provide an Allen wrench grip that is ergonomically sized and designed for usage in combination with an Allen wrench or hex wrench.

It is an object of the present invention to provide an Allen wrench grip that receives an Allen wrench at either end or via a plurality of different positioned apertures.

It is an object of one embodiment of the present invention to provide an Allen wrench grip that has a handle style grip.

It is an object of one embodiment of the present invention to provide an Allen wrench grip that has a shaft style grip.

It is an object of one embodiment of the present invention to provide an Allen wrench grip that has a removable shaft style.

### BRIEF DESCRIPTION OF THE FIGURES

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A. shows a first side perspective view of a handle style grip of an Allen wrench grip.

FIG. 1B shows a first overhead environmental perspective view of a handle style grip of an Allen wrench grip used in combination with an Allen wrench.

FIG. 1C shows a second overhead environmental perspective view of a handle style grip of an Allen wrench grip used in combination with an Allen wrench.

FIG. 1D shows a third overhead environmental perspective view of a handle style grip of an Allen wrench grip used in combination with an Allen wrench.

FIG. 1E shows a fourth overhead environmental perspective view of a handle style grip of an Allen wrench grip used in combination with an Allen wrench.

FIG. 2A shows an overhead perspective view of a shaft style grip of an Allen wrench grip.

FIG. 2B shows a first overhead environmental perspective view of a shaft style grip of an Allen wrench grip used in combination with an Allen wrench.

FIG. 2C shows a second overhead environmental perspective view of a shaft style grip of an Allen wrench grip used in combination with an Allen wrench.

FIG. 3A shows a first overhead exploded perspective view of a removable shaft style of an Allen wrench grip in combination with a pair of Allen wrenches.

FIG. 3B shows a second overhead exploded perspective view of a removable shaft style of an Allen wrench grip in combination with a pair of Allen wrenches.

FIG. 3C shows a third overhead exploded environmental perspective view of a removable shaft style of an Allen wrench grip in combination with a pair of Allen wrenches.

### DETAILED DESCRIPTION OF THE INVENTION

Reference is made herein to the attached drawings. Like reference numerals are used throughout the drawings to depict like or similar elements of the Allen wrench grip. The figures are intended for representative purposes only and should not be considered to be limiting in any respect.

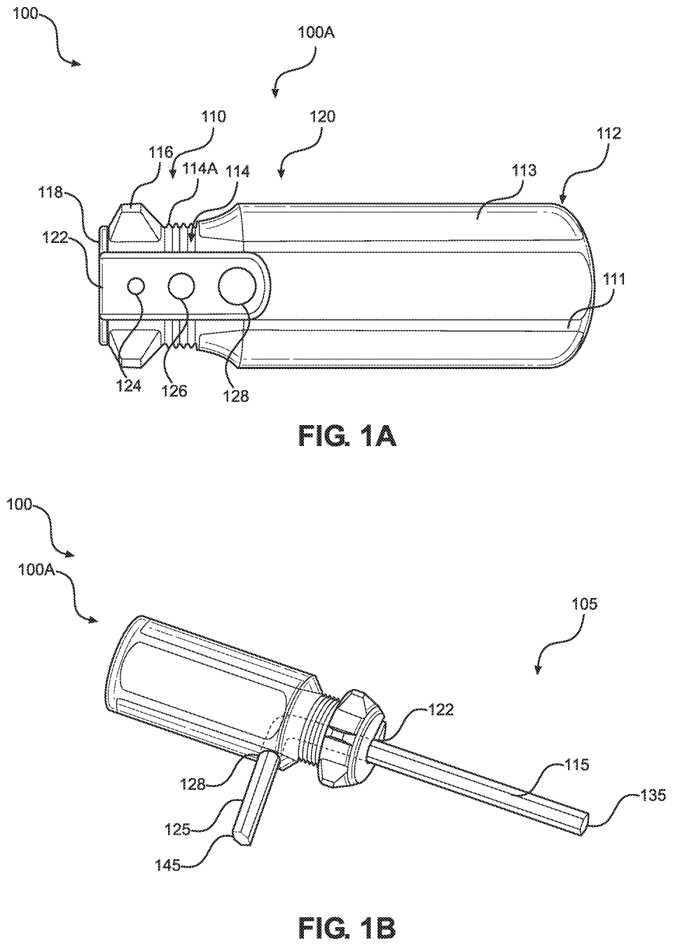

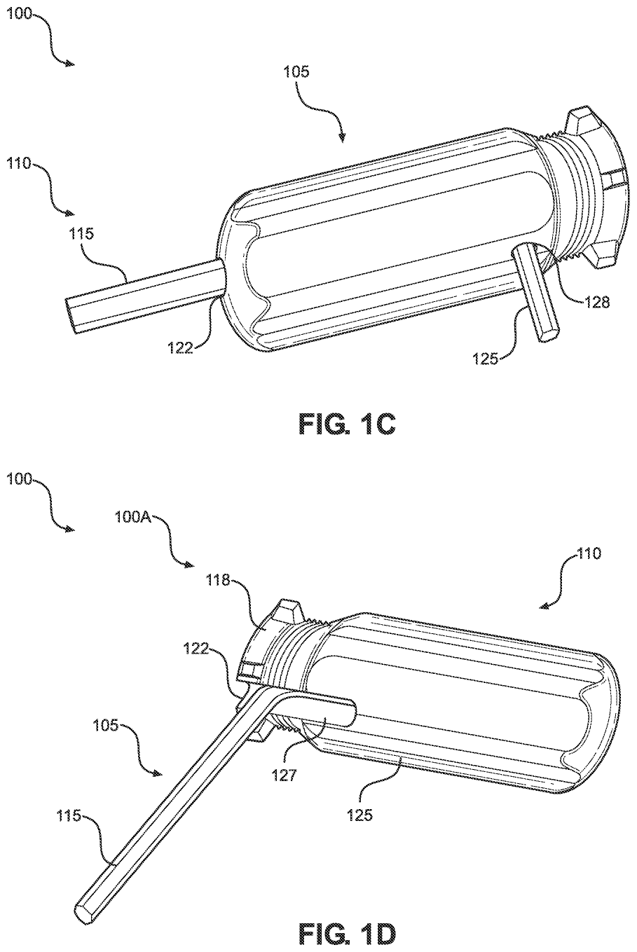

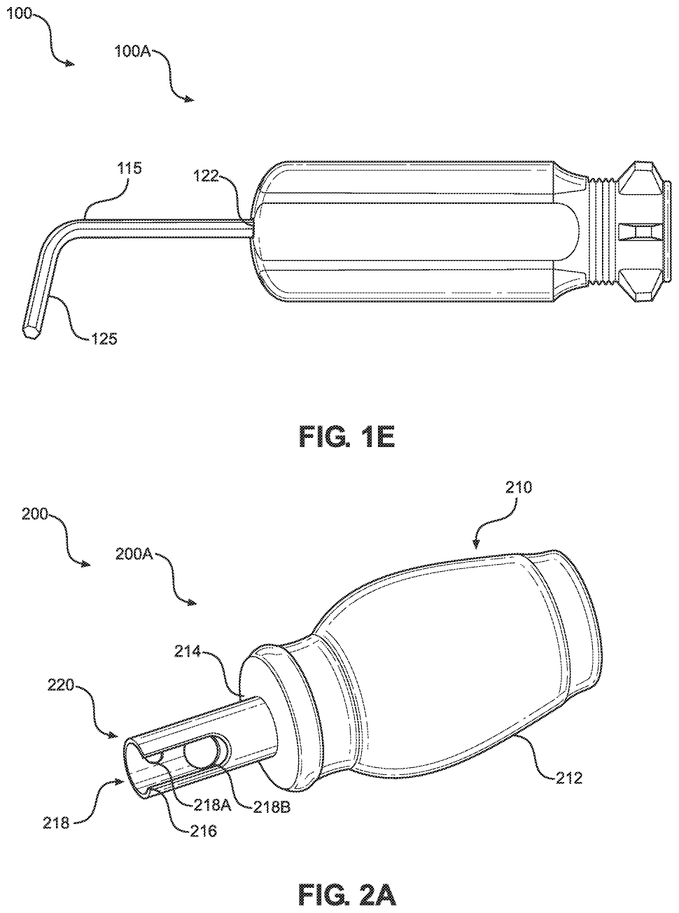

FIG. 1A. shows a first side perspective view of a handle style grip 1004A of an Allen wrench grip 100.

The handle style grip 100A may include an elongated screwdriver handle 110 and a plurality of holes 120.

The elongated screwdriver handle 110 may include an elongated gripping surface 112, an indented portion 114, a raised portion 116, and a top portion 118. The elongated gripping surface 112 may include a plurality of relatively hard, smooth plastic strips 111 disposed lengthwise across the elongated screwdriver handle 110 and a plurality of relatively soft, tactile rubber strips 113 disposed lengthwise across the elongated screwdriver handle 110 that may be directly grasped by the user. The relatively hard, smooth plastic strips 111 and the relatively soft, tactile rubber strips 113 may be alternatingly disposed on the elongated screwdriver handle 110. The elongated screwdriver handle 110 may be made of hardened plastic, hardened rubber, hardened polymer or the like.

The holes 120 may include a first hole 122, a second hole 124, a third hole 126, and a fourth hole 128. The first hole 122 may be disposed on the top portion 118 of the elongated screwdriver handle 110 to accommodate a standard Allen wrench or a standard Hex wrench (both not shown). The second hole 124 may be disposed on the raised portion 116 of the elongated screwdriver handle 110 to accommodate a standard Allen wrench or a standard Hex wrench (both not shown). The third hole 126 may be disposed on the indented portion 114 of the elongated screwdriver handle 110 to accommodate a standard Allen wrench or a standard Hex wrench (both not shown). The indented portion 114 of the elongated screwdriver handle 110 may also include a plurality of raised edges 114A that facilitate grasping the elongated screwdriver handle 110. The fourth hole 128 may be disposed on the elongated gripping surface 112 of the elongated screwdriver handle 110 to accommodate a standard Allen wrench or a standard Hex wrench (both not shown). The first hole 122, the second hole 124, the third hole 126, and the fourth hole 128 may be linearly aligned along the elongated screwdriver handle 110.

FIG. 1B shows a first overhead environmental perspective view of a handle style grip 100A of an Allen wrench grip 100 used in combination with an Allen wrench 105.

The Allen wrench 105 may include a first elongated portion 115, a second elongated portion 125, a first end 135, and a second end 145. The first elongated portion 115 of the Allen wrench 105 may be longer than the second elongated portion 125 of the Allen wrench 105. The first elongated portion 115 of the Allen wrench 105 may perpendicularly extend from the second elongated portion 125 of the Allen wrench 105. The first end 135 may be disposed on an end of the first elongated portion 115 of the Allen wrench 105 and the second end 145 may be disposed on an end of the second elongated portion 125 of the Allen wrench 105. The first end 135 and the second end 145 of the Allen wrench 105 may be used as an Allen wrench head to perform Allen wrench related functions.

The first elongated portion 115 of the Allen wrench 105 may extend through the first hole 122 of the elongated screwdriver handle 110 and the second elongated portion 125 of the Allen wrench 105 may extend through the fourth hole 128 of the elongated screwdriver handle 110. This may be a permanent orientation or the like.

FIG. 1C shows a second overhead environmental perspective view of a handle style grip 100A of an Allen wrench grip 100 used in combination with the Allen wrench 105.

The first elongated portion 115 of the Allen wrench 105 may extend through the first hole 122 of the elongated screwdriver handle 110 and the second elongated portion 125 of the Allen wrench 105 may extend through the fourth hole 128 of the elongated screwdriver handle 110. This may be a permanent orientation or the like.

FIG. 1D shows a third overhead environmental perspective view of a handle style grip 100A of an Allen wrench grip 100 used in combination with an Allen wrench 105.

The first elongated portion 115 of the Allen wrench 105 may extend through the second hole 124 of the elongated screwdriver handle 110. The second elongated portion 125 of the Allen wrench 105 may be disposed within an elongated slot 127 behind the second hole 124, the third hole 126, and the fourth hole 128 of the elongated screwdriver handle 110. This may be a permanent orientation or the like.

FIG. 1E shows a fourth overhead perspective view of a handle style grip 100A of an Allen wrench grip 100.

The first elongated portion 115 and the second elongated portion 125 of the Allen wrench 105 may extend through the first hole 122. More specifically, the first elongated portion 115 of the Allen wrench 105 directly extends from the first hole 122. This may be a permanent orientation or the like.

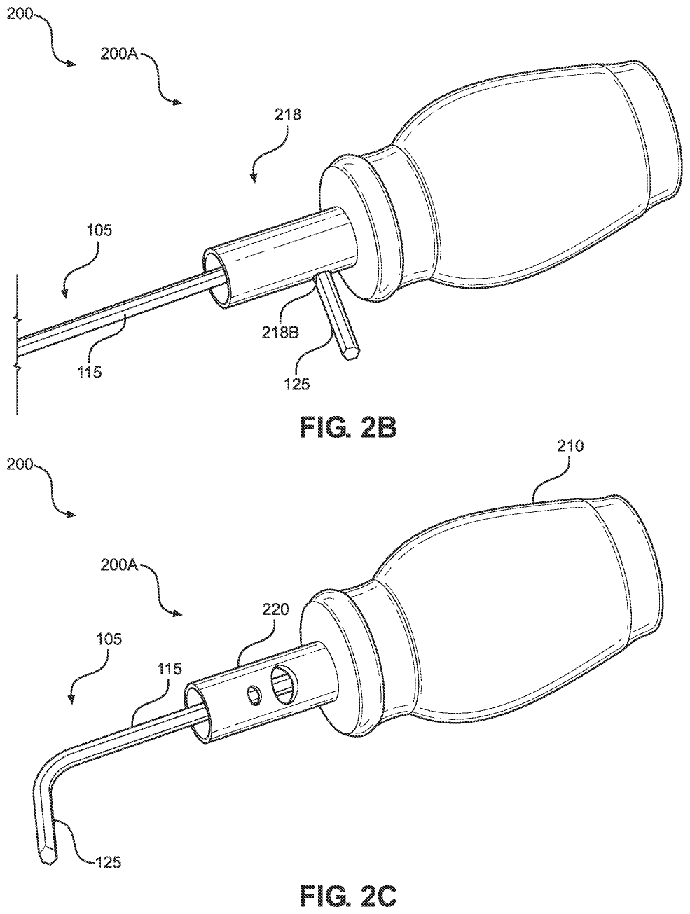

FIG. 2A shows an overhead perspective view of a shaft style grip 200A of an Allen wrench grip 200.

The shaft style grip 200A may include a bulb-shaped handle 210 and an extending shaft 220.

The bulb-shaped handle 210 may have a raised rounded middle 212 to facilitate grasping the raised rounded middle 212 and a top surface 214. The extending shaft 220 may extend from the top surface 214 and include a slot 216 and a pair of apertures 218. The extending shaft 220 may be hollow to receive the Allen wrench 105. The slot 216 and the pair of apertures 218 may also be hollow to receive the Allen wrench 105. The pair of apertures 218 may include a first aperture 218A and a second aperture 218B. The first aperture 218A may be relatively smaller than the second aperture 218B and the second aperture 218B may accommodate the Allen wrench 105. This may be a permanent orientation or the like.

FIG. 2B shows a first overhead environmental perspective view of a shaft style grip 200A of an Allen wrench grip 200.

The first elongated portion 115 of the Allen wrench 105 may extend upward through the extending shaft 220 and the second elongated portion 125 of the Allen wrench 105 may extend through the second aperture 218B of the pair of apertures 218. This may be a permanent orientation or the like.

FIG. 2C shows a second overhead environmental perspective view of a shaft style grip 200A of an Allen wrench grip 200.

The first elongated portion 115 of the Allen wrench 105 may directly extend upward through the extending shaft 220 and the second elongated portion 125 of the Allen wrench 105 may extend through the extending shaft 220 to be used as desired. This may be a permanent orientation or the like.

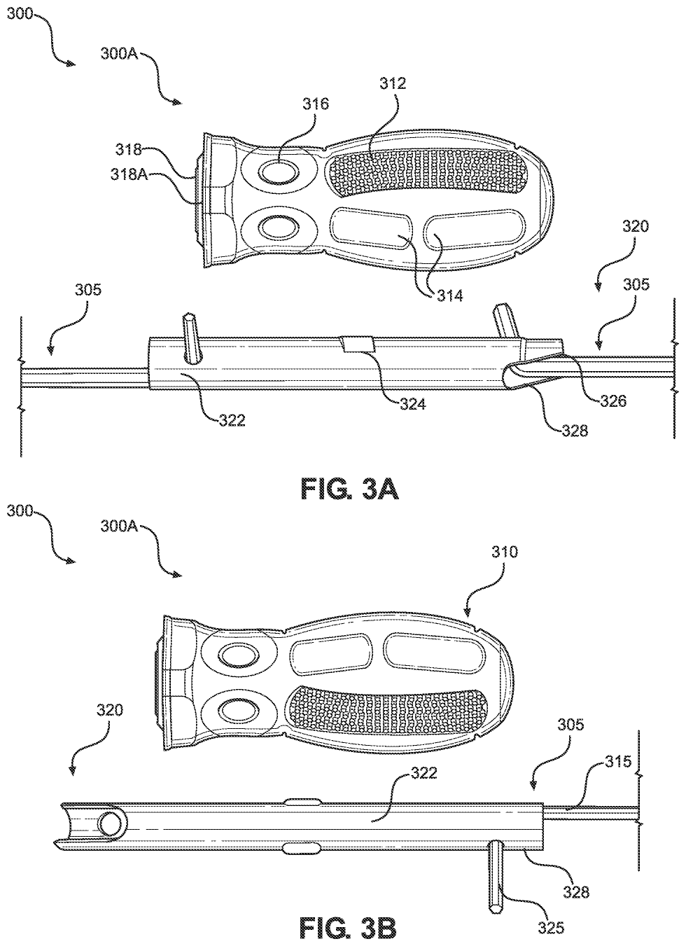

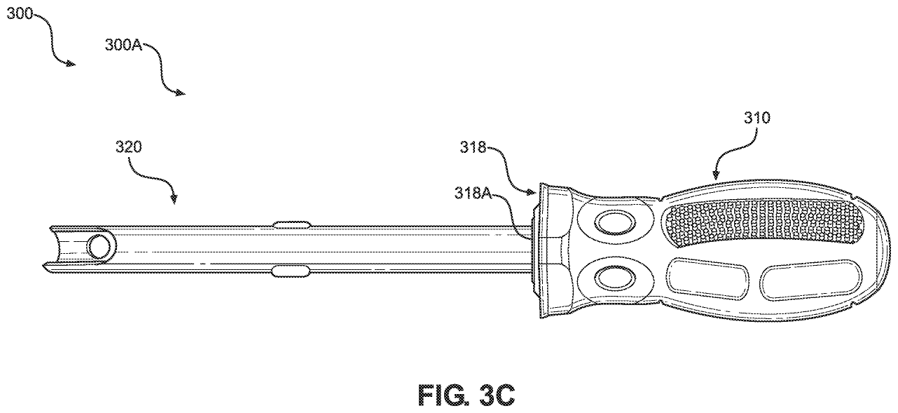

FIG. 3A shows a first overhead exploded environmental perspective view of a removable shaft style 300A of an Allen wrench grip 300 in combination with an Allen wrench 305.

The removable shaft style 300A may include an elongated handle 310, a removable shaft 320, and a pair of Allen wrenches 305.

The elongated handle 310 may include a plurality of raised edge surfaces 312, a plurality of tactile surfaces 314, a plurality of indentations 316, and a top surface 318. The raised edge surfaces 312, the tactile surfaces 314, and the indentations 316 may facilitate grasping the elongated handle 310 and provide ergonomic comfort and the like. The top surface 318 may include a centered hole 318A that is disposed on the top surface 318 of the elongated handle 310.

The removable shaft 320 may include a hollow body 322, a pair of grasping notches 324, a pair of end notches 326, and a pair of apertures 328. The hollow body 322 may be entirely hollow and be made of metal material or the like. The pair of grasping notches 324 may be disposed and centered on the hollow body 322 to facilitate grasping the removable shaft 320. The pair of end notches 326 may each be provided on each end of the removable shaft 320. The pair of apertures 328 may each be disposed across from each of the pair of end notches 326 on the hollow body 322. The removable shaft 320 may be removably inserted into the centered hole 318A as desired by a user.

The pair of Allen wrenches 305 may each include the same features as the Allen wrench 105 described and illustrated in FIG. 1B to perform Allen wrench related functions.

FIG. 3B shows a second overhead exploded environmental perspective view of a removable shaft style 300A of an Allen wrench grip 300 in combination with an Allen wrench 305.

One of the pair of Allen wrenches 305 may be inserted into one of the pair of apertures 328 of the hollow body 322. More specifically, the second elongated portion 325 of the Allen wrench 305 may extend through one of the pair of apertures 328 and the first elongated portion 315 of the Allen wrench 305 may extend out of the hollow body 322 adjacent to the one of the pair of apertures 328.

FIG. 3C shows a third overhead exploded environmental perspective view of a removable shaft style 300A of an Allen wrench grip 300 in combination with an Allen wrench (not shown).

The removable shaft 320 may be removably inserted into the centered hole (FIG. 3A, 318A) that is disposed on the top surface 318 of the elongated handle 310. The removable shaft 320 may receive any portion of the Allen wrench (FIG. 3B, 305) to be used as an Allen wrench head to perform Allen wrench related functions.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A handle style Allen wrench grip, comprising:
an elongated screwdriver handle having an elongated gripping surface, an indented portion, a raised portion, and a top portion;
a plurality of holes including a first hole, a second hole, a third hole, and a fourth hole, the first hole is disposed on the top portion of the elongated screwdriver handle to accommodate an Allen wrench;
wherein the second hole, the third hole, and the fourth hole are disposed on the elongated screwdriver handle to accommodate the Allen wrench; and
wherein the Allen wrench includes a first elongated portion, a second elongated portion, a first end, and a second end.

2. The handle style Allen wrench grip, according to claim 1, wherein the elongated gripping surface includes a plurality of hard, smooth plastic strips disposed lengthwise across the elongated screwdriver handle and a plurality of soft, tactile rubber strips disposed lengthwise across the elongated screwdriver handle that are directly grasped by a user.

3. The handle style Allen wrench grip, according to claim 1, wherein the indented portion of the elongated screwdriver handle includes a plurality of raised edges that facilitate grasping the elongated screwdriver handle.

4. The handle style Allen wrench grip, according to claim 1, wherein the elongated screwdriver handle is made of a material selected from the group consisting of a hardened plastic, a hardened rubber, or a hardened polymer.

5. The handle style Allen wrench grip, according to claim 1, wherein the first elongated portion of the Allen wrench is longer than the second elongated portion of the Allen wrench and the first elongated portion of the Allen wrench is perpendicularly extended from the second elongated portion of the Allen wrench.

6. The handle style Allen wrench grip, according to claim 1, wherein the first elongated portion of the Allen wrench is extended through the first hole of the elongated screwdriver handle and the second elongated portion of the Allen wrench is extended through the fourth hole of the elongated screwdriver handle.

7. The handle style Allen wrench grip, according to claim 1, wherein the first elongated portion of the Allen wrench is extended through the second hole of the elongated screwdriver handle and the second elongated portion of the Allen wrench is disposed within the first hole extending from the top portion of the elongated screwdriver handle.

8. A shaft style Allen wrench grip, comprising:
a bulb-shaped handle having a raised rounded middle to facilitate grasping the raised rounded middle and a top surface; and
an extending shaft extending from the top surface, the extending shaft includes a slot and a pair of apertures;
wherein the pair of apertures include a first aperture and a second aperture;
wherein the extending shaft is hollow to receive an Allen wrench;
wherein the Allen wrench includes a first elongated portion, a second elongated portion, a first end, and a second end; and
wherein the slot and the pair of apertures are hollow to receive the Allen wrench.

9. The shaft style Allen wrench grip, according to claim 8, wherein the first aperture is smaller than the second aperture and the second aperture accommodates the Allen wrench.

10. The shaft style Allen wrench grip, according to claim 8, wherein the first elongated portion of the Allen wrench extends upward through the extending shaft and the second elongated portion of the Allen wrench extends through the second aperture of the pair of apertures.

11. The shaft style Allen wrench grip, according to claim 8, wherein the first elongated portion of the Allen wrench is directly extended upward through the extending shaft and the second elongated portion of the Allen wrench is extend through the extending shaft.

12. The shaft style Allen wrench grip, according to claim 8, wherein the elongated screwdriver handle accommodates a Hex wrench in place of the Allen wrench.

13. A removable shaft style Allen wrench grip, comprising:
an elongated handle having a plurality of raised edge surfaces, a plurality of tactile surfaces, a plurality of indentations, and a top surface;
a removable shaft including a hollow body, a pair of grasping notches, a pair of end notches, and a pair of apertures; and
a pair of Allen wrenches;
wherein the raised edge surfaces, the tactile surfaces, and the indentations facilitate grasping the elongated handle and provide ergonomic comfort.

14. The removable shaft style Allen wrench grip, according to claim 13, wherein the top surface includes a centered hole to receive the removable shaft.

15. The removable shaft style Allen wrench grip, according to claim 13, wherein the hollow body is entirely hollow and is made of metal.

16. The removable shaft style Allen wrench grip, according to claim 13, wherein the pair of grasping notches are disposed and centered on the hollow body to facilitate grasping the removable shaft.

17. The removable shaft style Allen wrench grip, according to claim 13, wherein the pair of end notches are each provided on each end of the removable shaft.

18. The removable shaft style Allen wrench grip, according to claim 13, wherein the pair of apertures are each disposed across from each of the pair of end notches on the hollow body.

19. The removable shaft style Allen wrench grip, according to claim 13, wherein the removable shaft is removably inserted into the centered hole that is disposed on the top surface of the elongated handle to receive any portion of the Allen wrench used as an Allen wrench head to perform one or more Allen wrench related functions.

20. The removable shaft style Allen wrench grip, according to claim 13, wherein the elongated handle accommodates a Hex wrench in place of the Allen wrench.
